(19) United States
(12) Patent Application Publication
(10) Pub. No.: US 2024/0352240 A1
(43) Pub. Date: Oct. 24, 2024

(54) HDPE BLENDS OF VIRGIN POLYETHYLENE AND POST CONSUMER RECYCLATE FOR BLOWN FILMS AND METHODS THEREOF

(71) Applicant: Equistar Chemicals, LP, Houston, TX (US)

(72) Inventors: Matthew A. Sonnycalb, Dayton, OH (US); Robert Scott Weber, Mason, OH (US); Emily A. Silber, Cincinnati, OH (US); D. Ryan Breese, Loveland, OH (US)

(73) Assignee: Equistar Chemicals, LP, Houston, TX (US)

(21) Appl. No.: 18/637,014

(22) Filed: Apr. 16, 2024

Related U.S. Application Data
(60) Provisional application No. 63/461,042, filed on Apr. 21, 2023.

(51) Int. Cl. C08L 23/06; B29B 7/00; B29B 7/48; B29K 23/00; B29K 105/00; B29K 105/26; C08J 3/00; C08J 5/18

(52) U.S. Cl. CPC C08L 23/06; C08J 3/005; C08J 5/18; B29B 7/007; B29B 7/484; B29K 2023/06; B29K 2023/065; B29K 2105/0094; B29K 2105/26; B29K 2995/0022; B29K 2995/0025; B29K 2995/0063; B29K 2995/0077; C08J 2323/06; C08J 2423/06; C08L 2205/025; C08L 2207/062; C08L 2207/20

(57) ABSTRACT

Compounded virgin polyethylene and post-consumer recyclate HDPE compositions with improved processability and mechanical properties, including processes of making, products and application including general purpose films and food packaging are described herein.

### PRIOR RELATED APPLICATIONS

This application claims the benefit of priority to U.S. Provisional Application No. 63/461,042, filed on Apr. 21, 2023, which is incorporated herein by reference in its entirety.

### FEDERALLY SPONSORED RESEARCH STATEMENT

Not applicable.

### FIELD OF THE DISCLOSURE

The disclosure generally relates to blends of virgin polyethylene and post-consumer recyclate (“PCR”) high density polyethylene with improved processability and properties, including processes of making the blends, and products and applications thereof.

### BACKGROUND OF THE DISCLOSURE

Heightened standards of living and increased urbanization have led to an increased demand for polymer products, particularly polyolefin plastics. Polyolefins have been frequently used in commercial plastics applications because of their outstanding performance and cost characteristics. Polyethylene (“PE”) is a thermoplastic polyolefin made from petroleum and has become one of the most widely used and recognized polyolefins because PE is strong, extremely tough, and very durable. This allows PE to be highly engineered for a variety of applications.

Mostly applications rely on “virgin” PE, which is PE that originates from feedstock that has never been used by a consumer—that is, non-recycled material. For example, high density polyethylene (“HDPE”) has a density that may range from about 0.94 to about 0.97 g/cm³ and has little branching of monomers. This combination offers strong intermolecular forces and tensile strength. Other properties of HDPE include its corrosion resistance, a large strength to density ratio, plus it is meltable and moldable. Furthermore, HDPE can be manufactured in such a way that it is consider food safe and can be used in food packaging and storage, although not all HDPE is food safe. Because of its strength and relative non-toxicity, virgin HDPE is used in a variety of applications requiring high-impact resistance and melting points, including plastic bottles, milk jugs, shampoo bottles, bleach bottles, freezer and shopping bags, cutting boards, piping, etc.

Recycled HDPE may be used in applications similar to virgin HDPE, including use in bottles, piping material, outdoor plastic furniture, automobile parts, etc. However, reusable packaged products produced by recycled HDPE do not always meet the USDA requirements for direct contact with drug and/or food products made for human consumption. Similarly, other types of PE, including medium density PE (MDPE), low density PE (LDPE), and linear low density PE (LLDPE) experience different applicability for their virgin and recycled counterparts.

To reduce plastic manufacturing and disposal, efforts have been ongoing to recycle plastics, but recycling processes often degrade the polymers. Thus, there have also been efforts to blend virgin and recycled plastics to provide higher quality materials. Unfortunately, blending polymers with different properties may also introduce additional variables into the finished product that may be undesirable or may produce a product of inferior quality. Thus, there is a need in the art to provide better methodology and products that combine virgin and recycled plastics.

Provided in this disclosure are methods of blending virgin polyethylene(s) and PCR HDPE to make plastics that retain or improve the properties of either the virgin or post-consumer recyclate plastic for the intended end use, and may be usable in film, food and beverage industry.

### SUMMARY OF THE DISCLOSURE

This disclosure provides compounded virgin polyethylene(s) with recycled HDPE polymers to create a blend that has a density range from about 0.94 to about 0.97 g/cm³, thus making it a HDPE blend. The resulting HDPE blends have melt indexes of 0.1-2 g/10 min wherein the melt index is measured at 190° C. under 2.16 kg force, and have both good processing capability, as well as good film characteristics. The blends can be used as-is, or with addition of one or more additives, in blown film applications. Alternatively, the blends can be added to a composition having one or more virgin resins to “let down” the recycled content in the final product.

In some embodiments of the present disclosure, the virgin PE resin can be a LLDPE, LDPE, MDPE, HDPE, or combinations thereof. The selection of the virgin PE will depend on the properties required in the final blend or intended application of blend, as well as the amount of HDPE PCR used.

While the recycled polyolefin in the present application is preferably HDPE, it is understood that there may be other types of polymers present as the recycled HDPE is obtained after use by e.g. a consumer and is often from a waste stream. In some embodiments of the present application, the recycled HDPE has an HDPE content of at least 90 wt. %, at least 95 wt. %, at least 99 wt. % or 100 wt. %. The remaining content, if present, may be other types of PE or polypropylene, as well as other polymers and materials used in consumer or industrial goods.

### DETAILED DESCRIPTION

The present disclosure relates to processing or mixing of at least one virgin polyethylene (“virgin PE”) plastic with post-consumer recyclate HDPE in processing plants to provide a compounded plastic. The plastics, having been previously and independently extruded and pelletized, may be fed independently or in combination into an extruder. In the extruder, the plastics may be melted and mixed, and then extruded and pelletized for subsequent applications as a single pellet solution.

In one embodiment, the plastics (virgin PE and PCR HDPEs) may be mixed in an extruder using a single screw extruder. Testing the single screw blending method, indicated that it may be less preferred where high quality films are needed. Compositions made in single-screw extrusion may have significant gels in the resulting films. This may be acceptable for certain applications, but for high quality films, a higher shear compounding method is preferred.

In another embodiment, a co-rotating twin screw extruder or any other high shear method may be used to mix or otherwise compound the virgin and recycled polymers. In one embodiment of a twin-screw compounding extruder, two intermeshing, co-rotating screws mounted on splined shafts in a closed barrel are used. The compounded plastics of the present disclosure may be more homogeneously mixed in a twin screw extruder as compared to a single screw extruder, but any sufficiently high shear method could be used, such as continuous mixers, Banbury mixers, and the like. In one embodiment, the virgin PE and the PCR HDPE are melt compounded with a specific mechanical energy greater than about 0.05 kW-hr/kg; alternatively, from 0.05 kW-hr/kg to 0.5 kW-hr/kg; and alternatively, from 0.05 kW-hr/kg to 0.4 kW-hr/kg.

Further details on co-rotating twin-screw extruders for compounding HDPE may be found in James L. White and Eung K. Kim in Twin Screw Extrusion: Technology and Principles (2^{nd} Ed.) Carl Hanser Verlag, Munich 2010; Klemens Kohlgruber and Werner Wiedmann, in Co-rotating Twin-Screw Extruders: Fundamentals, Technology, and Applications, Hanser, Munich 2008; Chan I. Chung in Extrusion of Polymers: Theory and Practice, Carl Hanser Verlag, Munich 2000; and Paul Anderson in Mixing and Compounding of Polymers (2nd Ed), Ed. Manas-Zloczower, Tadmore 2009, Chapter 25, p. 947, the contents of which are each hereby incorporated by reference in their entireties for all purposes.

For preparation of plastic films for the industrial packaging industry or the food packaging industry, blown film extrusion or blown film coextrusion or hot blown processes, and the like may be used. In one embodiment of a blown bubble process, plastic in the form of small beads or pellets may be fed through a feed coat to a barrel that contains a rotating screw attached that forces the plastic pellets forward to a heated barrel. At a desired extrusion temperature set by the process and the type of desired plastic output, molten plastic may be formed that leaves the circular extrusion die as a film. Air pressure may be used to further expand the film in the form of a bubble. After the expansion to the desired dimensions, the film may be cooled to solidify it. Films may be defined as less than 0.254 mm (10 mils) in thickness, although blown films can be produced as high as 0.5 mm (20 mils).

During any film extrusion process, the desired film may have a constant gauge. Formation of a stable bubble in a blown bubble process may be therefore important to make good films. However, barrier performance is often another important factor for choosing material for packaging industry to extend the shelf-life of foods.

Melt Index (“MI”) is a measure of the ease of flow of the melt of a plastic. In the blown bubble film process, the bubble stability may decrease with increasing MI, with an example of an upper limit for MI being about 2.0 g/10 min.

Another parameter used in developing the blends of this disclosure is molecular weight distribution (“MWD”). All synthetic polymers are polydisperse in that they contain polymer chains of unequal length, and so the molecular weight is not a single value—the polymer exists as a distribution of chain lengths and molecular weights. By targeting a somewhat broader distribution of chain lengths, the compounded polymers have both good performance characteristics (as an example, acceptable moisture barrier properties for the film applications) and improved processing characteristics (for example, bubble stability and extruder output in film applications).

In one embodiment, the compounded polyethylene compositions of the present disclosure has a MWD as assessed by M_{w}/Mₙ of at least 6. In another embodiment, the compounded polyethylene composition has an M_{w}/Mₙ of at least 8, alternatively at least 10, alternatively at least 12, alternatively from about 6 to about 15, alternatively from about 8 to about 13. In some embodiments, the MWD is about 8.5 or about 12.14.

The compounded polymers of the disclosure were tested and found a satisfactory bubble stability and a MI of about 0.2-2 g/10 min, about 40 to 95% PCR and an M_{w}/Mₙ of at least 6 or 6-15, even when the films are thinner than currently used films.

In more detail, at least one virgin PE is combined with a suitable post-consumer recyclate HDPE to produce a blend with a MI of about 0.2-2 g/10 min, a density of 0.94 to about 0.97 g/cm³, an M_{w}/Mₙ greater than about 6, and improved processability. This is achieved by high shear melt mixing of the virgin PE and PCR HDPE in, for example, a twin-screw compounding extruder, also called “single pellet” solution. The blend can be used in multi-layer film structures to balance overall PCR content in the plastic, material cost and film gauge.

The compounded plastic will typically have an intermediate level of MI, depending on the ratios of the two plastics used. In general, the ratio of the two components is selected to target a final blend MI of from 0.2 to 2.0 g/10 min, alternatively from 0.3 to 1.0 g/10 min, alternatively from 0.7 to 1.0 g/10 min or about 0.3 or about 0.7 g/10 min.

The virgin and/or recycled HDPE of the present disclosure may have an M_{w}/Mₙ greater than about 6. In an alternative embodiment, the virgin and/or recycled HDPE of the present disclosure may have an M_{w}/Mₙ greater than 8, 10, or 12, and alternatively between 6 and 15. The compounded material may have a similar distribution as the starting materials, or an intermediate value if plastics with differing M_{w}/Mₙ are used. However, in general a larger M_{w}/Mₙ in the final product is preferred, e.g., ≥6, ≥8, ≥10, ≥12, ≥14, and the like, as it improves the processability. Ranges include M_{w}/Mₙ of 6-15, 6-10, 11-15, or 8-13.

The recycled HDPE starting materials may have a density above 0.94 g/cm³. In an alternative embodiment the recycled HDPE of the present disclosure may have a density ranging from about 0.945 to 0.960 g/cm³. In an alternative embodiment the virgin and/or recycled HDPE of the present disclosure may have a density ranging from about 0.949 to 0.956 g/cm³. The virgin polyethylene will have a density relative to its type, wherein a virgin HDPE will have a density range of from about 0.940 to 0.960 g/cm³, but a virgin LLDPE will have a density range of from about 0.910-0.940 g/cm³. The compounded HDPE blend may have a similar density or intermediate the two if the starting materials have different densities, but will always fall within the range of 0.940 to 0.970 g/cm³, allowing the blend to be classified as an HDPE.

In one embodiment, the compounded polymers may have at least 40 wt. % recycled HDPE, preferably at least 45, 60, 70, 80 or about 90 wt. % recycled HDPE. Lower amounts of PCR are possible; however most commercial film lines are multi-layer coextrusions with 3 to 11 layers, and in a multilayer film, targeting a higher PCR concentration may be desirable, as some layers (such as sealant layers, tie layers, high barrier layers, etc.) may need to remain 100% virgin to maintain overall multilayer film performance. Thus, multilayer film structures can be created to balance the overall film barrier performance, total PCR content, the use of lower cost materials and film gauge (for cost saving and additional sustainability impact). In other embodiments, a higher concentration of PCR will allow the blend to be used in and “let down” into another material to add PCR content.

The virgin PE and recycled HDPE blend can therefore be used in multi-layer film structures to balance overall PCR content in the plastic, moisture barrier, material cost and film gauge.

The compounded plastic and sheets or films made therefrom can be used in any product typically made with HDPE, include for example, plastic bottles, plastic bags, shrink films, food safe containers, food safe and other films, cutting boards and other food processing equipment, water tanks, piping and fittings, toys, playground equipment, chemical containers, furniture, signage and fixtures, kick plates, fuel tanks, lockers, packaging, chute linings, vehicle interiors, and the like.

The present disclosure includes any one or more of the following embodiments, in any combination(s) thereof:

A compounded polymer having a) 5-60 weight % of a virgin polyethylene (virgin PE); b) 40-95 weight % of a post-consumer recyclate high density polyethylene (PCR HDPE); c) wherein said compounded polymer has a melt index of about 0.3-2.0 g/10 min and a density of about 0.940-0.970 g/cm³ and a weight averaged molecular weight/number averaged molecular weight (M_{w}/Mₙ) of ≥6; and d) wherein melt index is measured at 190° C. under 2.16 kg force.

Any compounded polymer herein described, wherein the compounded polymer is mixed using specific mechanical energy greater than 0.05 kW-hr/kg at a temperature over 125° C.; or 0.05-0.5 kW-hr/kg; or 0.20-0.4 kW-hr/kg. Preferably, the compounded polymer is mixed using a twin-screw compounding extruder at a temperature of 125-299° C., or 150-220° C., or 200-215° C.

Any compounded polymer herein described, wherein the compounded polymer has a M_{w}/Mₙ≥6.

Any compounded polymer herein described, wherein the virgin PE has a density of 0.910-0.440 g/cm³ and the PCR HDPE has a density of 0.940-0.970 g/cm³ and the compounded polymer has a density of about 0.956 g/cm³.

Any compounded polymer herein described, wherein the virgin HDPE and the PCR HDPE each have a density of 0.940-0.970 g/cm³ and the compounded polymer has a density of about 0.949 g/cm³.

Any compounded polymer herein described, wherein the ratio of virgin HDPE to PCR HDPE is about 5/95, 10/90, 20/80, 30/70, 45/55, 55/45 or 60/40.

Any compounded polymer herein described, wherein the virgin HDPEPE and the PCR HDPE are food safe and/or the resulting compounded polymer is food safe.

Any compounded polymer herein described, said compounded polymer comprising 10-55 weight % of a virgin polyethylene having a melt index of about 0.1-18 g/10 min; 45-90 weight % of a PCR HDPE having a melt index of about 0.5-0.85 g/10 min; and wherein said compounded polymer has a melt index of about 0.3-0.7 g/10 min and a density of about 0.945-0.960 g/cm³ and an M_{w}/Mₙ≥6.

A polymeric film made from any compounded polymer herein described. Preferably, the film has 90% fewer gels than a similar polymer compounded with a single screw extruder. Preferably the film has a defect count less than 175 defects per meter² for a defect size between 500 mm and 7500 mm, or a defect count less than 80 defects per meter² for a defect size between 750 mm and 1000 mm, or a defect count less than 1 defects per meter² for a defect size between 1250 mm and 2000 mm.

A multilayer film comprising one or more layers of any compounded polymer herein described and one or more layers of virgin polymer.

As used herein, the term ‘virgin’ refers to an unused material, as provided by the manufacturer.

As used herein, ‘PCR’ or ‘post-consumer recycled’ plastic refers to plastic that has been molded into a product, used by the consumer and then recycled.

As used herein, the term ‘compounded plastic’ or ‘compounded polymer’ or ‘blended polymer’ refers to a homogeneous blend containing virgin and PCR HDPE, and possibly other minor additives.

As used herein, the percentage of virgin PE or recycled HDPE is a weight percentage of the polymers, and excludes any minor additives such as colorants, lubricants, and the like.

As used herein, the ‘melt index’ (‘MI’) or ‘melt flow index’ (‘MFI’) refers to the measurement of the rate of extrusion of molten resins through a standard die (2.095×8 mm) according to ASTM D1238-20 (procedure B) at 190° C. and under 2.16 kg force. It is defined as the weight of polymer in grams flowing in 10 min through a standardized capillary under a standard load at a given temperature. In general, plastic with a high MI indicates a lower material viscosity, and MI is compared to compare flow characteristics of two plastics.

As used herein, the ‘molecular weight distribution’ or ‘MWD’ as well as the number averaged molecular weight (“Mₙ”) and weight averaged molecular weight (“M_{w}”), are determined using a high temperature Polymer Char gel permeation chromatography (“GPC”), also referred to as size exclusion chromatography (“SEC”).

In more detail, GPC was equipped with a filter-based infrared detector, IR5, a four-capillary differential bridge viscometer, and a Wyatt 18-angle light scattering detector. M_{w}, Mₙ, MWD, and short chain branching (SCB) profiles were reported using the IR detector, whereas long chain branch index, g′, was determined using the combination of viscometer and IR detector at 145° C. Three Agilent PLgel Olexis GPC columns were used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer was weighted in a 10 mL vial and sealed for the GPC measurement. The dissolution process was obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns were calibrated based on twelve monodispersed polystyrene (PS) standards ranging from 578 g/mole to 3,510,000 g/mole. The comonomer compositions (or SCB profiles) were reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique.

GPC one software was used to analyze the data. The long chain branch index, g′, was determined as follows:

$${g}^{′} = [ η ] {/ [ η ]}_{lin}$$

where, [η] is the average intrinsic viscosity of the polymer derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Plastic film thickness is commonly measured using a micrometer ASTM-D6988 or ASTM-D8136. Mil is a common unit of thickness measurement for plastic films. Thickness is also commonly represented in gauge. A simple conversion is 1 mil=100 gauge=25.4 micron.

As used herein, “OCS” or “optical control system” is a method of determining film quality whereby a high-resolution camera takes pictures of the film and identifies and quantitates gels or imperfections. The software is configured to classify the gels and report out a composite gel counts. U.S. Pat. No. 7,393,916 provides exemplary details of OCS and the composite gel count.

As used herein, a ‘gel’ refers to imperfections in a polymeric film. Gels are localized imperfections that are visually distinct from the surrounding film, and can be caused by uncompounded polymers, unreacted catalysts, etc.

“Downgauge” or “downgauging a plastic film” as used herein means to make a plastic film that is thinner. This is done for a number of reasons, including sustainability, reducing material cost, or based on application needs.

As used herein, the term “Food safe” refers to an article that complies with government regulations related to food safety. For example, “food safe” includes, but is not limited to, an article or coating that comply with regulations of the U.S. Food and Drug Administration (“USFDA”), the U.S. Drug administration (“USDA”), European Food Safety Authority (“EFSA”), the China Food and Drug Administration (“CFDA”), the Canadian Food Inspection Agency, and the like. “Food safe” may include compliance with Title 21 of the Code of Federal Regulations (e.g., 21 CFR §§ 174.5-178.3950).

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed, and excludes all additional elements. The phrase “consisting essentially of” excludes additional material elements, but allows the inclusions of non-material elements that do not substantially change the nature of the disclosure, such as instructions for use, colorants, lubricants, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| ASTM | American Society for Testing and Materials |
| EVA | ethylene vinyl acetate |
| GPC | Gel permeation chromatography |
| HDPE | High Density Polyethylene |
| LDPE | Low Density Polyethylene |
| LLDPE | Linear Low Density Polyethylene |
| MD | Machine direction |
| MDPE | Medium Density Polyethylene |
| MI | Melt Index, also MFI or melt flow index |
| M_{w}/Mₙ | M_{w}/Mₙ is called the molar-mass dispersity index (often called polydispersity |
| | index (PDI)). Mn is the number averaged MW, and Mw is the weight averaged |
| | MW. The midpoint of the distribution in terms of the number of molecules is |
| | M_{w}. If all polymer chains are exactly the same, then the number-average |
| | and weight average molecular weights are exactly the same and the PDI is |
| | 1. The larger the molar-mass dispersity index, the wider is the molecular |
| | weight distribution. |
| MWD | Molecular weight distribution, see also M_{w}/Mₙ |
| NMR | Nuclear magnetic resonance |
| OCS | Optical Control System |
| PCR | Post consumer recyclate |
| PDI | polydispersity index, see also MWD and M_{w}/Mₙ |
| PS | Polystyrene |
| SCB | short chain branching |
| TD | Transverse direction |

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

### Blending of Virgin PE and Recycled HDPE

Samples were prepared by compounding a virgin PE with a recycled HDPE. The resulting blend is classified as a HDPE based on density.

For Sample 1, a virgin LLDPE (“LLDPE 1”) having a higher MI (such as without limitation a cast film grade like GA1832, MI of 3.2 g/10 min, density=0.918 g/cm³, melting temperature 123° C., and available from LyondellBasell Industries, Houston, TX) was selected for compounded with a lower MI PCR grade polymer with an average MI of 0.7 g/10 min (such as the PCR HDPE EcoPrime C+ available from Envision Plastics, Reidsville, NC), using the high melt twin-screw compounding extruder single pellet method, followed by characterization using OCS.

For Samples 2, 3, and 4, a virgin HDPE (“HDPE 1”) having a lower MI (such as without limitation blown film grade LP540200, MI of 0.17 g/10 min, density=0.940 g/cm³, melting temperature 126° C., and available from LyondellBasell Industries, Houston, TX) was compounded with a higher MI PCR grade polymer with an average MI of 0.7 g/10 min (such as the PCR HDPE EcoPrime C+ available from Envision Plastics, Reidsville, NC), using the high melt twin-screw compounding extruder single pellet method, followed by characterization using OCS. Certain properties of the virgin plastics are shown in Table 1.

TABLE 1
Properties of Virgin PE resins

| | LLDPE 1 | HDPE 1 |
|---|---|---|
| Physical Properties | | |
| Density (g/cm³) | 0.918 | 0.940 |
| Melt Flow Index (g/10 min) @Load | 3.2 | 0.17 |
| 2.16 kg, Temperature 190° C. | | |
| Mechanical Properties | | |
| Tensile Strength at Break (MPa) | 39 | 46.9 |
| Tensile Strength, Yield (MPa) | 23 | 21.9 |
| Elongation at Break (%) | 481 | 510 |

The recycled HDPE EcoPrime C+ by Envision Plastics was largely made from recycled milk jugs per US2013015604. The bottles were ground and sorted into flakes, which were cleaned in a wash line. The plastic was melted and formed into pellets, and then put through a proprietary process using heat and air to purify the plastic without the use of chemicals. As a result, even though recycled, the FDA allows its use at levels up to 100% in HDPE packaging for fatty foods and spirits.

Certain properties of the recycled plastic are shown in Table 2.

TABLE 2
ENVISION PLASTICS ECOPRIME C+

| | ASTM |
|---|---|
| Physical Properties | |
| Density 0.958-0.965 g/cm³ | D792 |
| Melt Index 0.5-0.90 g/10 min at 2.16 kg, 190° C. | D1238 |
| Moisture <0.050% | D6980 |
| Mechanical Properties | |
| Flex modulus 111,500 psi | D790 |
| Elongation at Break 197% | D638 |
| Impact resistance 4.5 ft-lb/in | D256 |
| Mold shrinkage Length 2.98% | |
| Mold shrinkage Width 2.6% | |

The formulations of the samples are in Table 3 below.

TABLE 3
Formulation of Samples

| | Amount of PCR (wt. %) | Amount of virgin PE resin (wt. %) |
|---|---|---|
| Sample 1 | 90 | 10 (LLDPE 1) |
| Sample 2 | 45 | 55 (HDPE 1) |
| Sample 3 | 65 | 35 (HDPE 1) |

The method used for blending the virgin PE and recycled HDPE was carried out by a continuous process by introducing the plastic pellets simultaneously into a twin-screw extruder. Typically for HDPEs, compounding is performed at barrel set temperature range of 150-220° C. and varying screw speeds of the twin-screw extruder. Typical extruder temperature profiles are about 180/200/210/210/210° C. with residence times ranging from 5 to 60 seconds.

In more detail, the proof of concept work was done with extruder barrel temperature that ranged from 150° C. at the feed throat and 220° C. at the die, although ranges of 125-299° C. are acceptable, and can vary even further depending on the starting materials. The extruder output was set to 100 lbs/hr, but can range from about 50-150 lbs/hr. The specific mechanical energy was 0.05 kW-hr/kg, but can include ranges of about 0.05-0.5 kW-hr/kg. The extruder screw speed used was 300 rpm, but ranges of about 200-400 or even wider are acceptable, providing that sufficient mixing is achieved.

Certain properties of the compounded samples are found in Table 4.

TABLE 4
COMPOUNDED VIRGIN PE and PCR HDPE

| | Sample 1 | | Sample 2 | | Test method |
|---|---|---|---|---|---|
| Melt Index | 0.7 | g/10 min | 0.25 | g/10 min | ASTM D1238 |
| (190° C., | | | | | |
| 2.16 kg) | | | | | |
| Density (23° C.) | 0.956 | g/cm³ | 0.949 | g/cm³ | ASTM D1505 |

| | | | |
|---|---|---|---|
| MWD | 8.5 | 12.41 | — |

### Film Properties

A comparison of films was made between the compounded samples presently described and dry-blended version of the base resins.

For the compounded samples, a target of 2.0 mil thick plastic HDPE film was prepared using the high shear melt mixing twin-screw compounding extruder method described above and compared against a similar film made from the same ingredients prepared with a single low shear screw method without screens to size limit the material. The melt temperature in the single screw extruder was set to 169° C., the rpm was 50 and the output was 10 lbs/hr.

The data on film composition using Sample 1 and characteristics was obtained using OCS camera attached to the extruder system and are presented in Table 5.

TABLE 5
Defect Distribution comparison for Single Pellet
and Dry Blend polymer blends for Sample 1

| Defect Distribution Size | | |
|---|---|---|
| avg/[m²] | Dry Blend | Single Pellet |
| Total Defect (ppm) | 2417 | 170 |

| | | | |
|---|---|---|---|
| 350 | micron | 9216 | 1397 |
| 500 | micron | 5604 | 421.9 |
| 750 | micron | 2316 | 76 |
| 1000 | micron | 430 | 4.2 |
| 1250 | micron | 101.7 | 0.7 |
| 1500 | micron | 23.8 | 0.2 |
| 1750 | micron | 6.9 | 0.1 |
| 2000 | micron | 1.5 | 0.0 |
| >2000 | micron | 0.6 | 0.1 |

The data on film composition using Sample 2 and characteristics was obtained using OCS camera attached to the extruder system and are presented in Table 6.

TABLE 6
Defect Distribution comparison for Single Pellet
and Dry Blend polymer blends for Sample 2

| Defect Distribution Size | | |
|---|---|---|
| avg/[m²] | Dry Blend | Single Pellet |
| Total Defect (ppm) | 420 | 75 |

| | | | |
|---|---|---|---|
| 350 | micron | 2014 | 630 |
| 500 | micron | 1139 | 182 |
| 750 | micron | 371 | 32 |
| 1000 | micron | 44 | 4 |
| 1250 | micron | 5 | 0 |
| 1500 | micron | 2 | 0 |
| 1750 | micron | 0 | 0 |
| 2000 | micron | 0 | 0 |
| >2000 | micron | 0 | 0 |

As seen from the table above, the defects in polymer film produced by single pellet solution as detected by OCS are significantly lower than film produced by dry blend. A total overall defect of about 179 ppm is observed in film prepared by the high shear compounding, whereas overall defects of 2417 was seen in films produced by dry blend.

Preliminary data on film composition using Sample 3, and characteristics was obtained using OCS camera attached to the extruder system and are presented in Table 7.

TABLE 7
Defect Distribution comparison for Single Pellet
and Dry Blend polymer blends for Sample 3

| | Defect | | |
|---|---|---|---|
| | Distribution | | |
| | Size avg/[m²] | Dry Blend | Single Pellet |
| Sample 3 | Total Defect | 305.8 | 140.8 |
| | (ppm) | | |

Using the high shear melt mixing using twin-screw compounding to blend the compounded resins, 90% overall reduction in gel level was observed with the reduction or elimination of the largest gels (˜1500 microns and above). Ideally, the method produces films with 85-95% fewer gels, and total defect levels of between 150-200 defects, 350 micron defect levels of 1000-1500, 500 micron defect levels of 350-650, 750 micron defect levels of 50-150, at least 1000 micron defect levels of fewer than 20, or fewer than 10, or fewer than 5. Indeed, less than 1 defect at levels larger than 1500 microns were observed, which contrasts with the film made by lower shear. The blending using twin-screw extruder also provided more consistent barrier properties with uniform heat seal strength and also improved aesthetics and consumer acceptance. Thus, high shear compounding is preferred, such as can be obtained by the twin-screw extruder or other high shear methods, such as continuous mixers, Banbury mixers, and the like.

Films Made with Virgin PE/Recycled HDPE

Monolayer films were created to balance the overall film performance PCR content, use of lower cost materials and film gauge—for cost saving and additional sustainability impact. Certain properties of Samples 2 and 4 are shown in Table 8 below.

TABLE 8
Properties of monolayered films made
with blends of virgin PE and PCR HDPE

| | Sample 2 | | Sample 3 | | Test method |
|---|---|---|---|---|---|
| Tensile strength at | 3610 | psi | 3539 | psi | ASTM D882 |
| break MD | | | | | |
| Tensile strength at | 2960 | psi | 2710 | psi | ASTM D882 |
| break TD | | | | | |
| Tensile strength at | 3390 | psi | 3730 | psi | ASTM D882 |
| yield MD | | | | | |
| Tensile strength at | 3920 | psi | 4170 | psi | ASTM D882 |
| yield TD | | | | | |
| Secant modulus | 107000 | psi | 118000 | psi | ASTM D882 |
| MD | | | | | |
| Secant modulus | 133000 | psi | 143000 | psi | ASTM D882 |

| | | |
|---|---|---|
| TD | | |
| Gloss | 9.6 | 9.8 |
| Haze | 60.4% | 61.2% |
| Oil Shrink MD | 78% | 77% |
| Oil Shrink TD | 18% | 9% |

These films showed excellent properties and would be useful in many film applications, including without limitation as for general purpose films and shrink films.

The foregoing disclosure describes preferred embodiments of the present disclosure. In view of this description, various changes and modifications may be suggested to one skilled in the art. For example, additional additives may be added to the above composition to achieve additional desired characteristics for a food grade composition. Accordingly, such changes and modifications should be considered within the scope of the present disclosure.

The following references are each incorporated by reference in their entireties for all purposes. The ASTM standards cited herein are used to measure the characteristics of the claimed polymers.

ASTM D256-10 Standard Test Methods For Determining The Izod Pendulum Impact Resistance Of Plastics.

ASTM D638-14 Standard Test Method For Tensile Properties Of Plastics.

ASTM D790-17 Standard Test Methods For Flexural Properties Of Unreinforced And Reinforced Plastics And Electrical Insulating Materials.

ASTM D792-20 Standard Test Methods For Density And Specific Gravity (Relative Density) Of Plastics By Displacement.

ASTM D1238-20 Standard test method for melt flow rates of thermoplastics by extrusion plastometer.

ASTM F1249-20 Standard test method for water vapor transmission rate through plastic film and sheeting using a modulated infrared sensor.

ASTM D6988-21 Standard guide for determination of thickness of plastic film test specimens.

ASTM D7310-21 Standard practice for defect detection and rating of plastic films using optical sensors.

ASTM D8136 Standard test method for determining plastic film thickness and

thickness variability using a non-toxic contact capacitance thickness gauge.

US2013015604 Process of Producing PCR Pellets.

U.S. Pat. No. 7,393,916 Method of reducing gels in polyolefins.

U.S. Pat. No. 10,124,527 Extrusion process for polyethylene polymers.

U.S. Pat. No. 10,138,310 Preparation of LLDPE resins and films having low gels.

Cutzwiler, G. W., et al., ‘Mixed post-consumer recycled polyolefins as a property tuning material for virgin polypropylene.’ J. Cleaner Production (2019) 239:117978. doi.org/10.1016/j.jclepro.2019.117978.

Todd, W. ‘Variables that affect/control high-density polyethylene film oxygen-moisture barrier.’ Journal of Plastic Film & Sheeting (2003) 19 (3): 209-220.

McKeen, L. W., Permeability properties of plastics and elastomers, Fourth Ed. (2017).

Albareeki, M. M.; Discoll, S. B.; Barry, C. F. ‘Compounding of polyethylene composites using high speed twin and quad screw extruders.’ AIP Conf. Proc. 2139 (2019), 020006. doi.org/10.1063/1.5121653.

What is claimed is:

1. A compounded polymer, said compounded polymer comprising:
a) 5-60 weight % of a virgin polyethylene (virgin PE) having a melt index of about 0.1-18.0 g/10 min;
b) 40-95 weight % of a post-consumer recyclate high density polyethylene (PCR HDPE) having a melt index of about 0.2 to about 1.0 g/10 min;
c) wherein said compounded polymer has a melt index of about 0.2-2.0 g/10 min and a density of about 0.945-0.960 g/cm³ and a weight averaged molecular weight/number averaged molecular weight (M_{w}/Mₙ) of >6; and
d) wherein melt index is measured at 190° C. under 2.16 kg force.

2. The compounded polymer of claim 1, wherein the compounded polymer is mixed using specific mechanical energy greater than 0.05 kW-hr/kg at a temperature over 125° C.

3. The compounded polymer of claim 2, wherein the compounded polymer is mixed using a twin-screw compounding extruder at a temperature of 125-299° C.

4. The compounded polymer of claim 1, wherein the compounded polymer has a M_{w}/Mₙ>8.

5. The compounded polymer of claim 1, wherein the compounded polymer has a M_{w}/Mₙ>12.

6. The compounded polymer of claim 1, wherein the virgin PE has a density of 0.915-0.970 g/cm³ and the PCR HDPE has a density of 0.940-0.970 g/cm³ and the compounded polymer has a density of about 0.945-0.960 g/cm³.

7. The compounded polymer of claim 1, wherein the ratio of virgin PE to PCR HDPE is about 10/90.

8. The compounded polymer of claim 1, wherein the ratio of virgin PE to PCR HDPE is about 55/45.

9. The compounded polymer of claim 1, wherein the virgin PE and the PCR HDPE are food safe.

10. The compounded polymer of claim 2, said compounded polymer comprising:
a) 10 weight % of a virgin PE having a melt index of about 3 g/10 min;
b) 90 weight % of a PCR HDPE having a melt index of about 0.5-0.90 g/10 min; and
c) wherein said compounded polymer has a melt index of about 0.7 g/10 min and a density of about 0.955-0.960 g/cm³ and an M_{w}/Mₙ>6.

11. The compounded polymer of claim 2, said compounded polymer comprising:
a) 55 weight % of a virgin PE having a melt index of about 0.17 g/10 min;
b) 45 weight % of a PCR HDPE having a melt index of about 0.5-0.9 g/10 min; and
c) wherein said compounded polymer has a melt index of about 0.3 and a density of about 0.945-0.953 g/cm³ and an M_{w}/Mₙ>6.

12. A polymeric film, said film comprising the compounded polymer of claim 3, wherein said film has at least 80% fewer gels than a similar polymer compounded with a single screw extruder, wherein said film has a thickness of less than 0.254 mm.

13. The film of claim 12, wherein said film has a defect count less than 175 defects per meter² for a defect size between 500 mm and 750 mm.

14. The film of claim 12, wherein said film has a defect count less than 80 defects per meter² for a defect size between 750 mm and 1000 mm.

15. The film of claim 12, wherein said film has a defect count less than 1 defects per meter² for a defect size between 1250 mm and 2000 mm.

16. A polymeric film, said film comprising the compounded polymer of claim 10, wherein said film has at least 90% fewer gels than a similar polymer compounded with a single screw extruder, wherein said film has a thickness of less than 0.254 mm.

17. The film of claim 16, wherein said film has a defect count less than 175 defects per meter² for a defect size between 500 mm and 750 mm.

18. The film of claim 16, wherein said film has a defect count less than 80 defects per meter² for a defect size between 750 mm and 1000 mm.

19. The film of claim 16, wherein said film has a defect count less than 1 defects per meter² for a defect size between 1250 mm and 2000 mm.

20. A process for preparing a compounded polymer, comprising the steps of:
a) adding into a hopper on a twin-screw compounding extruder a polymer composition comprising:
i) 5-60 weight % of a virgin polyethylene (virgin PE) having a melt index of about 0.1-18.0 g/10 min and
ii) 40-95 weight % of a post-consumer recyclate high density polyethylene (PCR HDPE) having a melt index of about 0.2 to about 1.0 g/10 min;
b) melting and mixing said polymer composition at a temperature of 125-299° C. and a specific mechanical energy greater than 0.05 kW-hr/kg using said twin-screw compounding extruder;
c) pushing the mixed polymer composition through a die to form said compounded polymer.
